(19) United States
(12) Patent Application Publication
(10) Pub. No.: US 2013/0042573 A1
(43) Pub. Date: Feb. 21, 2013

(54) COMPOSITE POLE AND METHOD FOR MAKING THE SAME

(71) Applicants: Conrad F. Fingerson, Rochester, MN (US); Charles Albert Hautamaki, Loveland, CO (US)

(72) Inventors: Conrad F. Fingerson, Rochester, MN (US); Charles Albert Hautamaki, Loveland, CO (US)

(73) Assignee: CONETT, INC., Stewartville, MN (US)

(21) Appl. No.: 13/642,225

(22) PCT Filed: Apr. 20, 2011
(86) PCT No.: PCT/US11/33207

§ 371 Date: Oct. 19, 2012

Related U.S. Application Data
(60) Provisional application No. 61/326,024, filed on Apr. 20, 2010.

(51) Int. Cl. E04C 3/36; B29C 63/18

(52) U.S. Cl. 52/834; 52/831; 264/259

(57) ABSTRACT

A composite pole includes at least a first composite member that includes first and second ends; an elongated body defined between the first and second ends; a first interior space; and a constant cross-section. The constant cross-section includes an outer circumference having a first radius and a second radius; an inner circumference; and a wall thickness defined between the outer and inner circumference. The first radius is not equal to the second radius.

### FIELD

This document relates generally to poles, and particularly, but not by way of limitation, to a composite pole including an oval cross-section and a method for making the same.

### BACKGROUND

Utility poles include electrical power poles, light poles, telephone poles and the like. Traditionally, utility poles are made from wood, steel and reinforced or prestressed concrete.

Wooden utility poles consist of a natural substance. The continuous exposure to harsh environmental conditions can cause the wood poles to rot and decay. To prevent rotting, the wood is sometimes treated with a carbon base material. It has been found that most conventional wood treating material is harmful to the environment. Additionally, it has been found that a significant amount of electrical current drains to the ground, thereby reducing the energy efficiency of the power grid.

Metal poles have been installed to increase the life of the utility poles. However, metal poles are substantially more expensive. Metal poles also are highly conductive, heavy and generally create an unsafe environment for the utility personnel that maintain and repair the power line.

Reinforced or prestressed concrete utility poles alleviate the conductivity problem of metal utility poles and alleviate the environmental problems of wooden poles. But concrete utility poles are significantly heavier than metal or wooden utility poles and the freight cost in transporting concrete utility poles throughout the countryside limits their use to areas close to the manufacturing plant where they are made.

Composite poles are used to resolve the above problems. Composite poles are formed from a combination of different materials each of which maintains their identities in the combination to produce a superior result than what could be achieved from individual materials acting alone. The composite for making poles is generally fiber-reinforced plastic or a fiber-reinforced polymer (FRP). A process for making composite poles typically is pultrusion, which is a continuous process including pulling a fiber reinforcing material through a resin impregnation bath and into a shaping die where the resin is subsequently cured. Typically, the dies used in the pultrusion process make a structure having a constant cross-sectional or two-dimensional shape.

For these and other reasons, there is a need for composite poles that are produced by proven manufacture process to be long lasting and able to withstand load requirements, while also being less expensive than steel and reinforced or pre-stressed concrete poles, particularly when poles become taller.

### SUMMARY

Disclosed herein is a composite pole, which can be used to support a utility line, a light, a signal light, or any other components of a utility system. The pole may also be used for other products that require elevated support by a pole type structure. The composite pole includes at least a composite member that includes a first end, a second end and an elongated body defined between the first and second ends. The elongated body has an oval-shaped cross-section. The composite pole can be made from a high strength to cost ratio and high stiffness to cost ratio material as compared to many competing materials via a pultrusion process. Therefore, material costs are reduced effectively since the oval-shaped composite pole can have a thinner side wall while maintaining the same or better strength and stiffness as compared to many standard utility poles. In addition, the resistance of fiber-reinforced plastic (FRP) to rust, rot and degradation from the sun help the life of the pole exceed competing materials.

By changing the dimensions of the sizes and thicknesses of its side walls, a composite pole with desired height and strength to weight ratio can be obtained. For example, special dimensions of the cross-section of the composite pole may be designed to maximize the pole's strength per weight ratios.

The composite pole is significantly lighter than those made of wood, metal or concrete, making them much easier to transport and install and thus reducing transportation and installation costs. In addition, the composite pole is resistant to all forms of degradation, such as ultraviolet light, rust, rot and deterioration from moisture and ground chemical.

In one embodiment, a composite pole includes at least a first composite member. The first composite member includes first and second ends; an elongated body defined between the first and second ends; a first interior space; and a constant cross-section. The constant cross-section includes an outer circumference having a first radius and a second radius; an inner circumference; and a wall thickness defined between the outer and inner circumferences. The first radius is not equal to the second radius.

In a further embodiment, a method for making a composite pole includes forming at least a first composite member. The first composite member includes first and second ends; an elongated body defined between the first and second ends; a first interior space; and a constant cross-section. The constant cross-section includes an outer circumference having a first radius and a second radius; an inner circumference; and a thickness defined between the outer and inner circumferences. The first radius is not equal to the second radius.

This summary is an overview of some of the teachings of the present application and not intended to be an exclusive or exhaustive description of the present subject matter. Further details about the present subject matter are found in the detailed description and appended claims. Other aspects will be apparent to persons skilled in the art upon reading and understanding the following detailed description and viewing the drawings that form a part thereof, each of which are not to be taken in a limiting sense. The invention is defined by the claims and their equivalents.

### DESCRIPTION OF THE DRAWINGS

The drawings, which are not necessarily drawn to scale, illustrate generally, by way of example, but not by way of limitation, various embodiments discussed in the present document.

FIG. 1 is a perspective view of a composite pole including an elongated body with an elliptical cross-section.

FIG. 2 is a cross-sectional view of the composite pole of FIG. 1 along line 2-2.

FIG. 3 is a diagrammatic view of a typical pultrusion production line for making a composite pole.

FIG. 4 is a cross-sectional view of a composite pole having an oval-shaped cross-section.

FIG. 5A is a cross-sectional view of a composite pole having an elliptical cross-section with a non-constant wall thickness.

FIG. 5B is a cross-sectional view of another composite pole having an elliptical cross-section with a non-constant wall thickness.

FIG. 6A is a cross-sectional view of a composite pole including a large composite member and a small composite member disposed in the large composite member, where the small composite member has a smaller wall thickness than that of the large composite member.

FIG. 6B is a cross-sectional view of a composite pole including a large composite member, a medium composite member disposed in the large composite member and a small composite member disposed in the medium composite member.

FIG. 6C is a cross-sectional view of a composite pole including a large composite member and a small composite member disposed in the large composite member, where the small composite member has a greater wall thickness than that of the large composite member.

FIG. 6D is a cross-sectional view of a composite pole including a large composite member and a small composite member disposed in the large composite member, where the small composite member has a wall thickness that equals to the wall thickness of the large composite member.

FIG. 7A is a cross-sectional view of a composite pole including a large composite member and a small composite member disposed in the large composite member, where the small composite member has a circular cross-section and portions of the outer circumference of the small composite member are in close proximity with the inner circumference of the large composite member.

FIG. 7B is a cross-sectional view of a composite pole including a large composite member and a small composite member disposed in the large composite member, where the small composite member has an elliptical cross-section and portions of the outer circumference of the small composite member are in close proximity with the inner circumference of the large composite member.

FIG. 8A is a cross-sectional view of a composite pole including a large composite member, a medium composite member disposed in the large composite member and a hollow small composite member disposed in the medium composite member, where portions of the outer circumference of the small composite member are in close proximity with the inner circumference of the medium composite member.

FIG. 8B is a cross-sectional view of a composite pole including a large composite member, a medium composite member disposed in the large composite member and a solid small composite member disposed in the medium composite member, where portions of the outer circumference of the small composite member are in close proximity with the inner circumference of the medium composite member.

### DETAILED DESCRIPTION

In the following detailed description, reference is made to the accompanying drawings which form a part thereof, and in which is shown by way of illustration specific embodiments in which the inventive concepts may be practiced. These embodiments are described in sufficient detail to enable those skilled in the art to practice the invention, and it is to be understood that the embodiments may be combined or used separately, or that other embodiments may be utilized and that structural and procedural changes may be made without departing from the spirit and scope of the inventive concepts. The following detailed description provides examples, and the scope of the present invention is defined by the claims to be added and their equivalents.

Disclosed herein is a composite pole, which can be used to support a utility line, a light, a signal light, or any other components of a utility system. The composite pole may also be used for other products that require elevated support by a pole type structure. The composite pole includes at least one composite member that includes a first end, a second end and an elongated body defined between the first and second ends. The elongated body has an oval-shaped cross-section. It is to be understood that the cross-section of the composite member can be in various shapes, including, but not limited to, elliptical or other oval shapes, circular, hollow, solid, etc.

The composite pole can be made from a high strength to cost ratio and high stiffness to cost ratio material as compared to many competing materials via a pultrusion process. Therefore, material costs are reduced effectively since the oval-shaped composite pole can have a thinner side wall while maintaining the same or better strength and stiffness as compared to many standard utility poles. In addition, the resistance of fiber-reinforced plastic (FRP) to rust, rot and degradation from the sun help the life of the pole exceed competing materials.

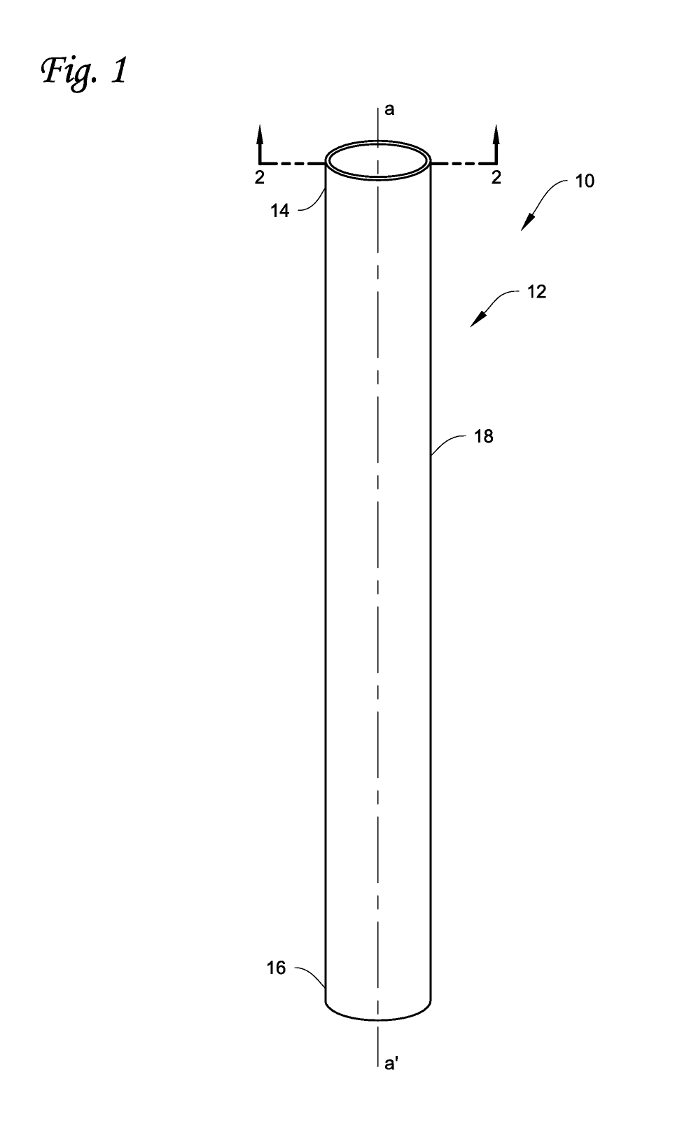

The terms “above,” “on,” “under,” “top,” “bottom,” “upper,” “lower,” “front,” “rear” and the like used herein are in reference to the relative positions of the composite pole and its constituent parts, in use when oriented as in FIGS. 1-4, 5A-B, 6A-D, 7A-B and 8A-B.

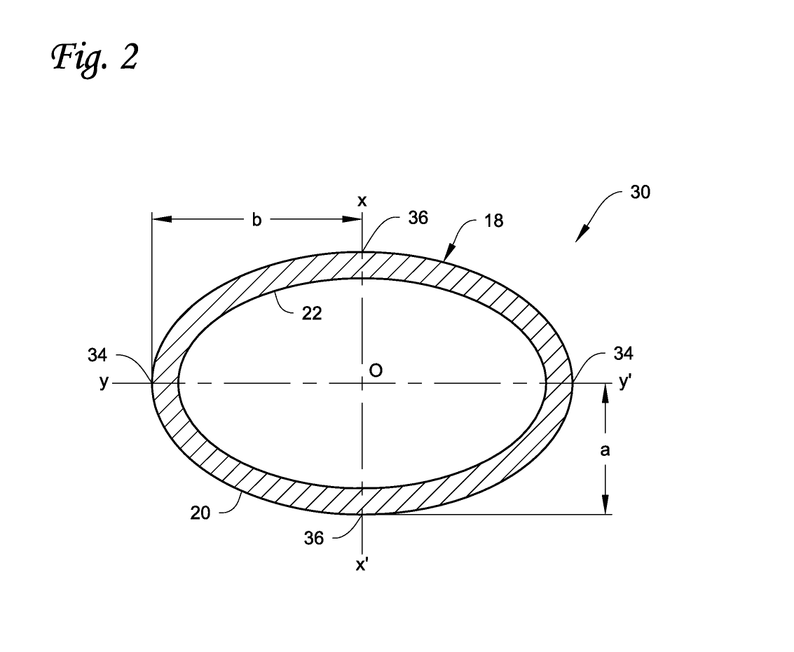

FIG. 1 is a perspective view of a composite pole 10 including a composite member 12 that has a first end 14, a second end 16 and an elongated body defined between the first and second ends 14, 16. With reference to FIGS. 1-2, the elongated body is hollow, including a side wall 18 having constant cross-sectional dimensions and a longitudinal axis a-a′. The side wall 18 has an outer circumference 20 and an inner circumference 22. An area enclosed by a cross sectional configuration of the elongated body taken at any plane perpendicular to the longitudinal axis a-a′, is ellipse in shape. The height of the composite pole 10 can vary depending on the required height and strength of the pole. In some embodiments, the height above the ground of the composite pole is in the range of 20-180 feet, and preferably 35-140 feet.

FIG. 2 illustrates an elliptical cross-section 30 of the composite member 12 of FIG. 1 along line 2-2, which is a constant cross-section down the length of the composite member. The cross-section 30 is centered on the longitudinal axis a-a′ at a geometry center O of the cross-section. The cross-section 30 includes the side wall 18 defined between the outer circumference 20 and the inner circumference 22, where both the outer and inner circumferences 20 and 22 are in elliptical shape.

In an alternative embodiment, the pole may be of some other oval cross-sectional shape, for example, a form of an asymmetrical generally irregular oval shape or even a polygonal shape but in a generally oval design, or a substantially symmetrical oval shape, like an elliptical shape, a circular shape, etc. Other suitable aerodynamic shapes (such as a tear-shaped cross-section) can also be used. It is to be understood that the area enclosed by the outer circumference 20 can vary as desired. In one embodiment, the area enclosed by the outer circumference 20 is in the range of approximately 50 square inches to approximately 2000 square inches.

The outer circumference 20 has a minor axis x-x′ and a major axis y-y′. The major axis y-y′ is the larger axis that runs in the direction of the largest dimension of the ellipse and bisects the ellipse. The minor axis x-x′ is perpendicular to the major axis and also bisects the ellipse. The length of the minor axis x-x′ is 2a, and the length of the major axis y-y′ is 2b. In one embodiment, the pole is oriented so that the major axis y-y′ is generally parallel to a major force acting or expected to act on the pole and the minor axis x-x′ is generally perpendicular to the major force acting or expected to act on the pole. It is to be understood that the ratio between the minor axis 2a and the major axis 2b may vary. The longer the major axis is, the greater resistance the composite member has to the bending moments occurring during use of the pole.

A portion of the outer circumference 20 has a smaller radius of curvature than a radius of another portion of the outer circumference. Specifically, with reference to FIGS. 1-2, the outer circumference has edges 34 that have the smaller radius and edges 36 that have the larger radius. The smaller radius at edges 34 helps reduce the wind resistance on the pole 10 during use of the pole.

With respect to FIG. 2, the side wall 18 has a constant thickness. It is to be understood that the thickness of the side wall can vary depending on the height of the composite pole and the loads expected to be applied to the pole. In some embodiments, the thickness of the side wall 18 can range from a quarter inch to one and a quarter inch.

By changing the dimensions of the height, cross-section, and thickness of the composite pole 10, a pole with desired strength and stiffness to weight ratio can be obtained. For example, special dimensions of the cross-section of the composite pole may be designed to optimize the pole's strength and stiffness per weight ratios for a given application. This can make the composite pole significantly lighter than those made of wood, metal or concrete, and as a result, make it much easier to transport and install and thus reducing transportation and installation costs.

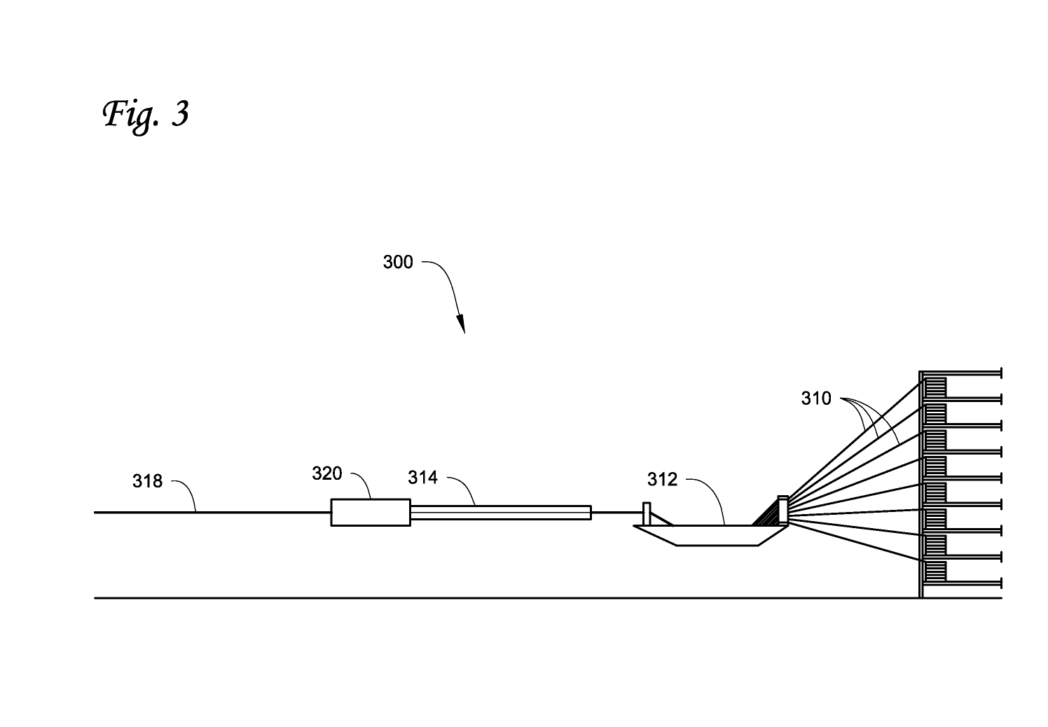

FIG. 3 is a diagrammatic view of a typical pultrusion production line for making a composite pole 10. The elongated body of the composite pole 10 can be made of fiber-reinforced plastic (FRP). Fiber-reinforced plastic is a composite material comprising a polymer matrix reinforced with fibers. The fibers include, but are not limited to fiberglass, jute, sisal, aramid fibers, carbon fibers, boron and other synthetic fibers. The polymer can be any polymer that is the matrix for a composite, such as epoxies, polyesters, urethanes, acrylics and other polymers.

A composite member for making the elongated body of the composite pole 10 can be manufactured by a pultrusion process by pulling a plurality of rovings through a resin impregnator and then through a pultrusion die. The resin is typically hardened by heat from the die and forms a rigid, cured profile that corresponds to the shape of the die. Those skilled in the art will recognize that a variety of oval shapes and sizes of pultruded profiles with constant cross-sections can be made by the pultrusion processes, for example, hollow, solid, elliptical, circular, hexagonal, octagonal, other irregular two dimensional shapes, etc. The shape of the cross-section is determined by the shape of the die.

With reference to FIG. 3, a composite member can be made through a typical pultrusion production line 300. One example of a suitable pultrusion production line is described in U.S. Pat. No. 5,492,583, filed on Jul. 6, 1994, entitled “Apparatus and Method for In-Line Coating of Pultrusion Profiles” which is incorporated herein by reference. As described in that patent, and illustrated herein in FIG. 3, one embodiment of the pultrusion process begins by pulling a plurality of rovings 310 through a resin impregnator 312 and then through a pultrusion die or dies 314. Another embodiment may also incorporate fiberglass mats or other mats to the inside and/or outside and/or interior of the composite member to provide cross strength. For example, the pultrusion process begins by pulling a plurality of rovings 310 and at least one mat, with a thickness of approximately 20 mil, through a resin impregnator 312 and then through a pultrusion die or dies 314. The mats can be formed on the outside, the inside and/or the interior of the pultruded profile, but in a preferred embodiment, one mat is formed on the outside of the pultruded profile and another mat is formed on the inside of the pultruded profile. The benefit of the mats is to provide an additional layer of cross strength to the utility pole. It will be apparent to those skilled in the art that the number or thickness of mats is a design choice and based on the calculated required cross strength of the utility pole, one or several may be necessary.

The resin is hardened by heat from the die or dies 314 and forms a rigid, cured profile having a constant cross-section that corresponds to the shape of the die or dies 314. A roving 310 typically consists of approximately 4000 individual glass fibers. It is to be understood that the sizes and numbers of rovings 310 can vary. In one embodiment, rovings 310 and a yield of 113 yards per pound have been used for this application. It should be recognized that other types of reinforcements such as carbon, aramid or a variety of man made or natural fibers can be used as the rovings 310. In addition, a portion of these fibers as well as the previously described glass fibers can be used in different forms such as in continuous strand mats, chopped strand mats, woven rovings or the like. A polyester thermoset resin could be used with the preferred embodiment; however, those skilled in the art would recognize that other types of resins including vinyl esters, epoxies, phenolics and a variety of thermoplastic resins could be used with the invention. It is to be understood that resin can comprise any percentage of the total material of the pultruded profile. In some embodiments, resin comprises 25% to 75% of the total material by volume of the pultruded profile. In a preferred embodiment, resin comprises 35% to 60% of the total material by volume of the pultruded profile.

The pultrusion die or dies 314 is typically heated to a temperature of 300° F. to 400° F. and has a length from about 48 to 72 inches to assure that the resin is cured or gelled before exiting the pultrusion die or dies 314 at run speeds that allow economical processing of pultruded profiles, typically in excess of 30 inches per minute. However, any type of die or dies and heating method that will cure and harden or gel (semi-cure) the resin before it exits the pultrusion die to dies 314 could be used. Those skilled in the art would recognize that other types of resins may require other impregnation methods, die designs or curing methods. Upon exiting the pultrusion die or dies 314 the pultruded profile 318 enters a coating die 320. The coating die 320 is an economical way of applying a weather protective coating to prevent surface degradation from ultraviolet rays to the outer surface of the pultruded profile 318. However, many types of thermoset type coating materials can be used with the coating die 320. Application of the coating material is not limited to use of the coating die 320 and can be applied by many types of machines made for this purpose, by spray processes, or by hand. At the end of the pultrusion process, a strong, yet light weight, pultruded profile 318 exits the pultrusion production line 300, where it can be cut to any desired length and further operations performed on it.

A pultruded profile manufactured by the pultrusion process can include thousands of unidirectional longitudinally oriented fibers. It is to be understood that the unidirectional, longitudinally oriented fibers can constitute a various percentage of the fibers. In some embodiments, the unidirectional, longitudinally oriented fibers constitute approximately 30% to 100% by volume of the fibers. Those skilled in the art will recognize that a variety of shapes and sizes of pultruded profiles 318 with constant cross-sections can be made by the pultrusion processes, determined by the shape of the die or dies 314.

In one embodiment, the average time to pull a composite member is under 20 minutes and the time to complete the pole will vary, depending on the number of secondary operations such as holes drilled, or hardware added at the factory. It will be appreciated that the times given are only approximations for a specific embodiment. The time can vary depending on the size of the composite member, the materials used, the methods used and the number and type of secondary operations performed.

In one embodiment, a utility pole can be made to be more resistant to surface degradation from ultraviolet (UV) light by adding a UV additive to the polymer. In addition, during the pultrusion process, a UV resistant polyester mat can be applied to the outside surface of the utility pole. To further protect the utility pole from UV degradation, a UV weather protective coating can also be applied during the pultrusion process, as shown at a coating die 320 in FIG. 3.

It is to be understood that for a shorter composite pole, a single profile can be pulled to make the elongated body; however, multiple profiles may need to be pulled for making a longer utility pole, where the multiple profiles are assembled at the factory or at the line construction site. The multiple profiles can have more than one advantage, including easy transportation, installation and lower cost.

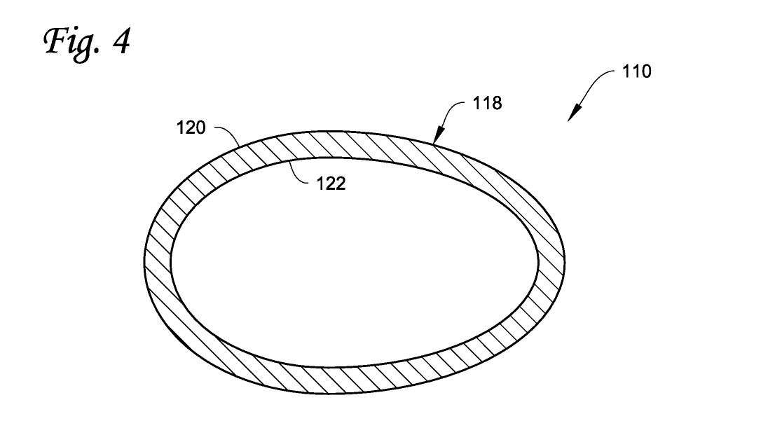

FIG. 4 is a cross sectional view of a composite pole 110 having an oval-shaped elongated body 112. The elongated body 112 includes a side wall 118 having an outer circumference 120 and an inner circumference 122, where the inner circumference 122 generally tracks the shape of the outer circumference 120 such that the side wall 118 has a constant thickness. In an alternative embodiment, the wall thickness of side wall 118 can also be non-constant. It is to be understood that the design of the oval-shaped side wall 118 can vary depending on the types of stresses expected to be encountered in a particular application. In a preferred embodiment, a portion of the outer circumference 120 has a smaller radius of curvature than a radius of another portion of the outer circumference 120.

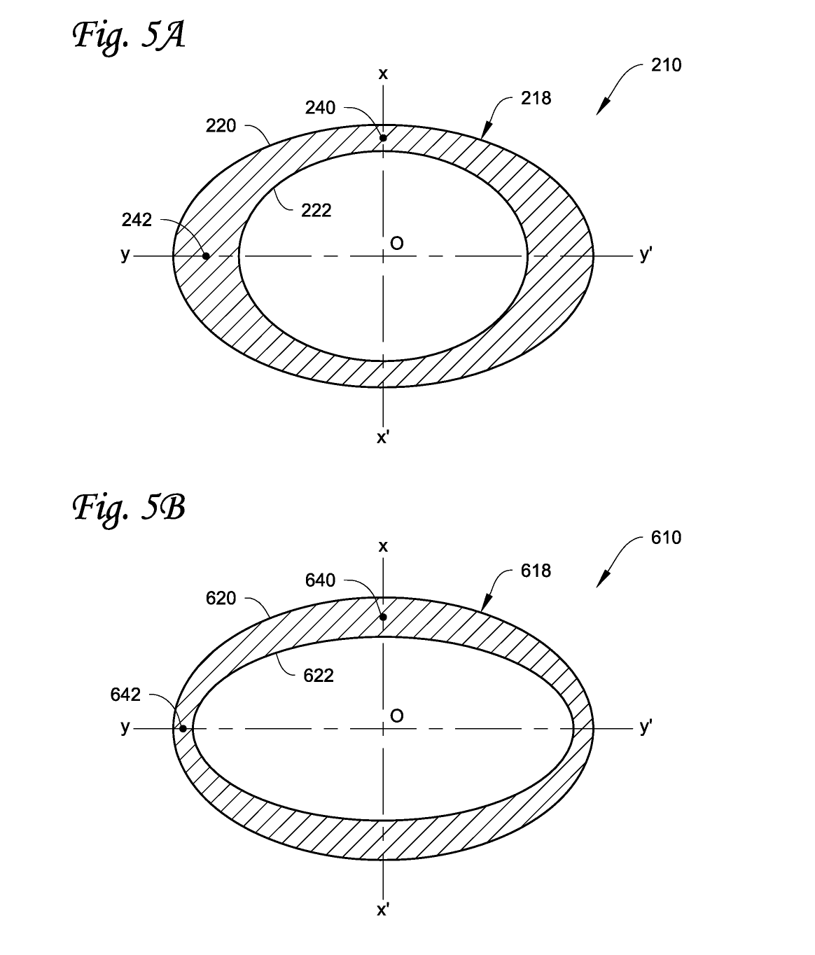

FIG. 5A is a cross-sectional view of a composite pole 210 including a side wall 218 having a non-uniform wall thickness forming an ellipse on the outer circumference 220 and another ellipse on the inner circumference 222. In the embodiment in FIG. 5A, specific wall thickness 240 of the side wall 218 is indicated on the minor axis x-x′ and specific wall thickness 242 is indicated on the major axis y-y′. The wall thickness increases, beginning from the minor axis x-x′ at thickness 240 gradually to the major axis y-y′ at thickness 242.

In an alternative embodiment as shown in FIG. 5B, a cross-sectional view of a composite pole 610 including a side wall 618 having a non-constant wall thickness forming an ellipse on the outer circumference 620 and another ellipse on the inner circumference 622. In the embodiment in FIG. 5B, specific wall thickness 640 of the side wall 618 is indicated on the minor axis x-x′ and specific wall thickness 642 is indicated on the major axis y-y′. The wall thickness decreases, beginning from the minor axis x-x′ at thickness 640 gradually to the major axis y-y′ at thickness 642.

It is to be understood that the outer circumference and the inner circumference can each take another form of oval shape, for example, a form of an asymmetrical generally irregular oval shape or even a polygonal shape but in a generally oval design, or a substantially symmetrical oval shape, like an elliptical shape, a circular shape, etc., depending on design choice. In the meantime, the configuration of the side wall with a non-constant wall thickness can also take other forms depending on the types of stresses to be distributed.

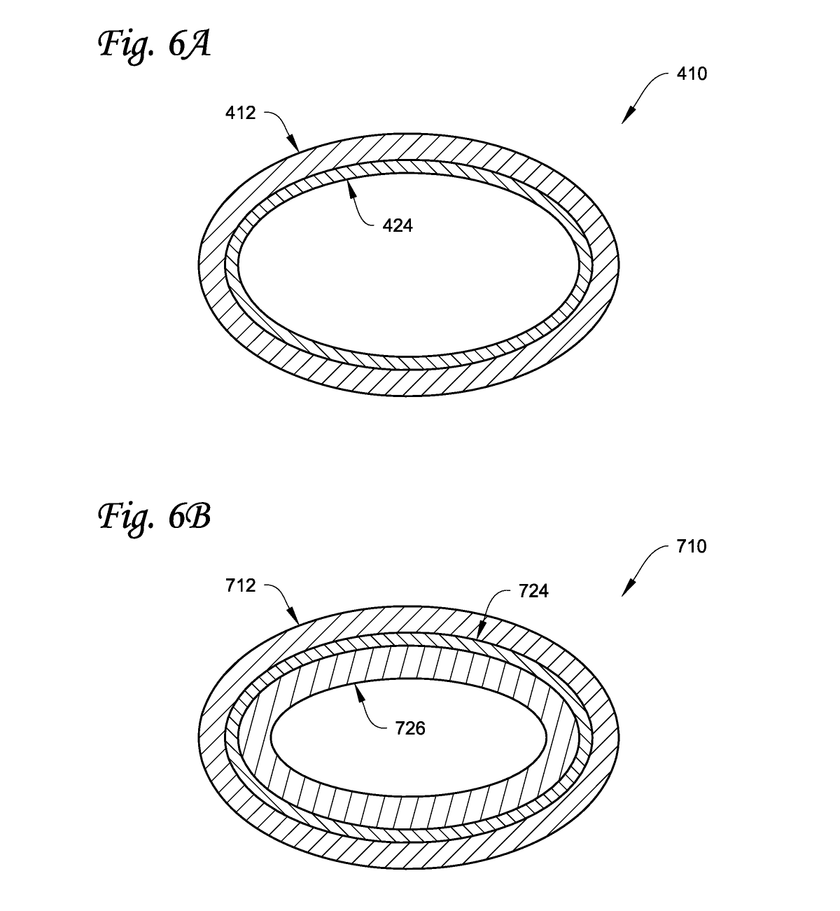

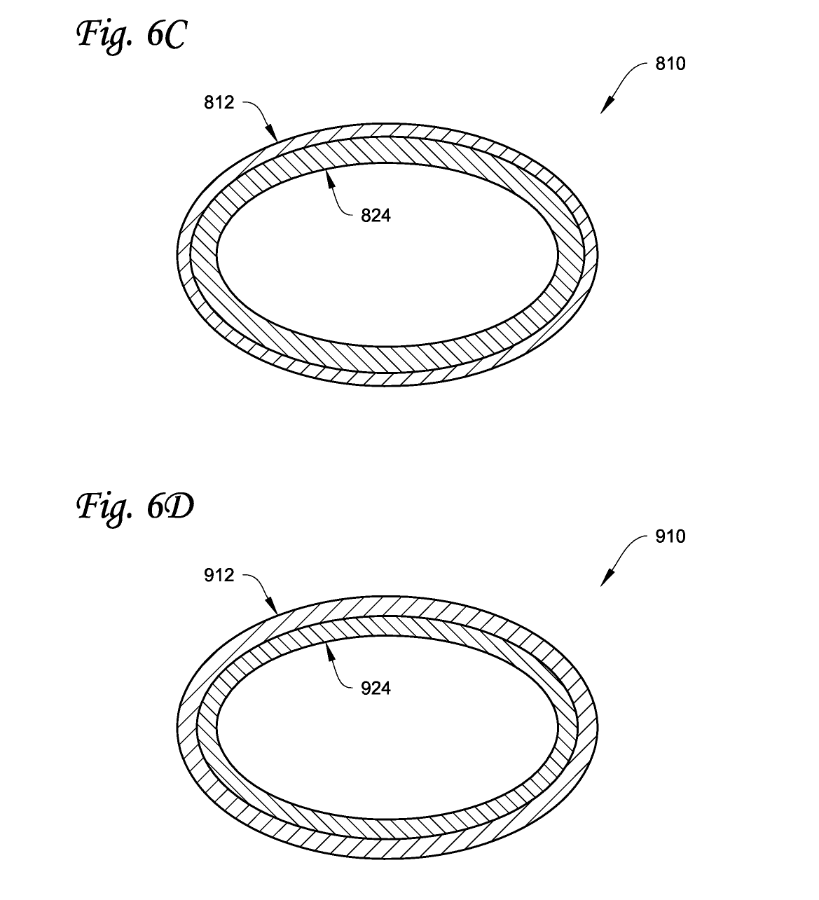

FIG. 6A is a cross-sectional view of a composite pole 410 that comprises a large composite member 412 including an interior space and a small composite member 424 at least partially nested or disposed in the interior space. As shown in FIG. 6A, the small composite member 424 has an outer circumference that is in close proximity with an inner circumference of the large composite member 412. The small composite member 424 is sized to facilitate telescopical slidable movement of the small composite member 424 in relation to the large composite member 412. The small composite member 424 can be retained in the large composite member 412 by using auxiliary means such as adhesive or mechanical means, for example, screws or rivets. The adhesive can be, for example, a thermosetting adhesive, a chemical adhesive, a contact adhesive, a hot adhesive, or a pressure adhesive made of, for example, a polyester or epoxy resin. In the embodiment as shown in FIG. 6A, the large composite member 412 has a greater wall thickness than that of the small composite member 424. In an alternative embodiment as shown in FIG. 6C, a composite pole 810 comprises a large composite member 812 including an interior space and a small composite member 824 at least partially nested or disposed in the interior space, where the large composite member 812 has a smaller wall thickness than that of the small composite member 824. In a further embodiment as shown in FIG. 6D, a composite pole 910 comprises a large composite member 912 including an interior space and a small composite member 924 at least partially nested or disposed in the interior space, where the large composite member 912 has an identical wall thickness as that of the small composite member 924.

In one embodiment as shown in FIG. 6B, a composite pole 710 comprises a large composite member 712 including a first interior space and a medium composite member 724 at least partially nested or disposed in the first interior space. The medium composite member 724 has an outer circumference that is in close proximity with an inner circumference of the large composite member 712. The medium composite member 724 is sized to facilitate telescopical slidable movement of the medium composite member 724 in relation to the large composite member 712. The medium composite member 724 can be retained to the large composite member 712 by using auxiliary means such as adhesive or mechanical means, for example, screws or rivets. The adhesive can be, for example, a thermosetting adhesive, a chemical adhesive, a contact adhesive, a hot adhesive, or a pressure adhesive made of, for example, a polyester or epoxy resin.

The medium composite member 724 includes a second interior space in which a small composite member 726 is at least partially nested or disposed. As shown in FIG. 6B, the small composite member 726 has an outer circumference that is in close proximity with an inner circumference of the medium composite member 724. The small composite member 726 is sized to facilitate telescopical slidable movement of the small composite member 726 in relation to the medium composite member 724. The small composite member 726 can be retained in the medium composite member 724 by methods similar to those discussed in the above paragraph.

In the embodiment as shown in FIG. 6B, the large composite member 712 has a greater wall thickness than that of the medium composite member 724, while the small composite member 726 has a greater wall thickness than that of the medium composite member 724. However, it is to be understood that the thicknesses of the composite members can vary or even can each be constant or non-constant as design choice.

It is to be understood that the specific configurations of the composite members in FIGS. 6A-D can vary, for example, as discussed above regarding the composite member, e.g., as in FIGS. 2, 4 and 5A-B, as long as an outer circumference of the smaller composite member is in close proximity with an inner circumference of the larger composite member. It is also to be understood that the thickness of the members can each take any form of thicker or thinner, constant or non-constant as design choice.

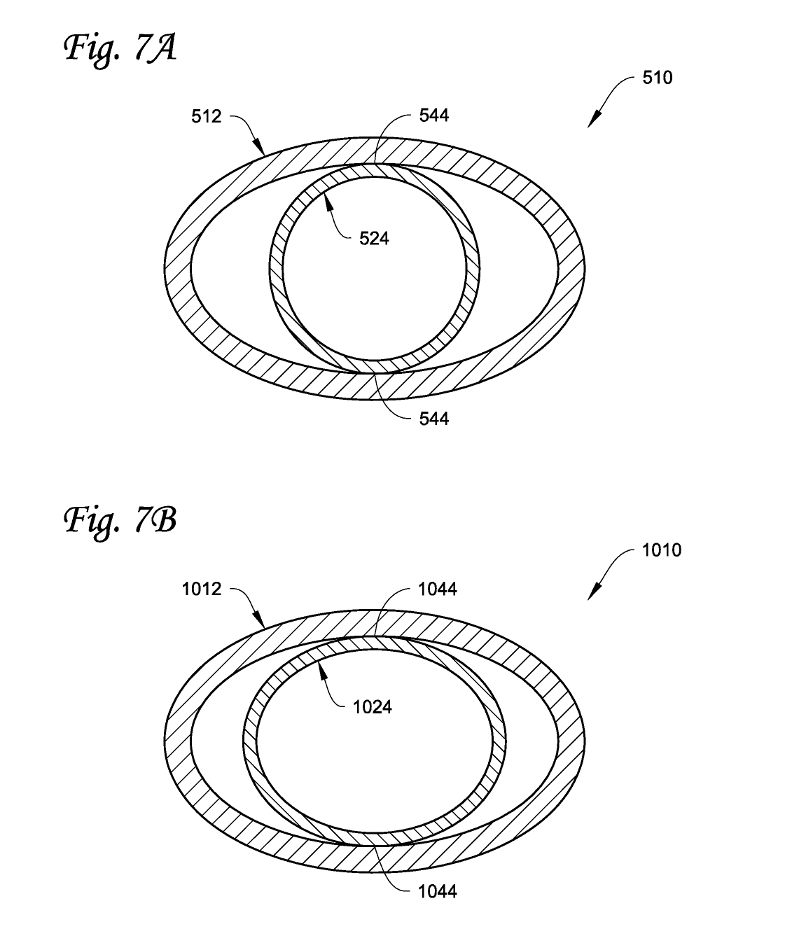

FIG. 7A is a cross-sectional view of a composite pole 510. The composite pole 510 comprises a large composite member 512 having an interior space and a small composite member 524 at least partially nested or disposed in the interior space. As shown in FIG. 7A, the small composite member 524 has an outer circumference that is in proximity with an inner circumference of the large composite member 512 at least at points 544. The small composite member 524 is retained to the large composite member 512 by methods similar to those discussed above regarding FIGS. 6A-D. In the embodiment as shown in FIG. 7A, the small composite member 524 is of a circular-shape and the larger composite member 512 is elliptical.

However, it is to be understood, that the large composite member 512 and the small composite member 524 can each have another oval form, for example, a form of an asymmetrical generally irregular oval shape or even a polygonal shape but in a generally oval design, or a substantially symmetrical oval shape, like an elliptical shape, a circular shape, etc. It is also to be understood that the thickness of the side walls of the large composite member 512 and the small composite member 524 can each be either constant or non-constant.

In an alternative embodiment as shown in FIG. 7B, a composite pole 1010 comprises a large composite member 1012 having an interior space and a small composite member 1024 at least partially nested or disposed in the interior space. As shown in FIG. 7B, the small composite member 1024 has an outer circumference that is in close proximity with an inner circumference of the large composite member 1012 at least at points 1044. The small composite member 1024 is retained to the large composite member 1012 by methods similar to those discussed above regarding FIGS. 6A-D. In the embodiment as shown in FIG. 7B, the small composite member 1024 and the large composite member 1012 are each in an elliptical shape. However, it is to be understood, that the large composite member 1012 and the small composite member 1024 can each have another oval form. It is also to be understood that the thickness of the side walls of the large composite member 1012 and the small composite member 1024 can each be either constant or non-constant.

It is to be understood that the specific configurations of the large composite member and the small composite member in FIGS. 7A-B can vary, for example, as discussed above regarding the composite member, e.g., as in FIGS. 2, 4 and 5A-B, as long as at least a portion of the an outer circumference of the small composite member is in close proximity with an inner circumference of the large composite member. It is also to be understood that the thickness of the large composite member or the small composite member can take any form of thicker or thinner, constant or non-constant as design choice.

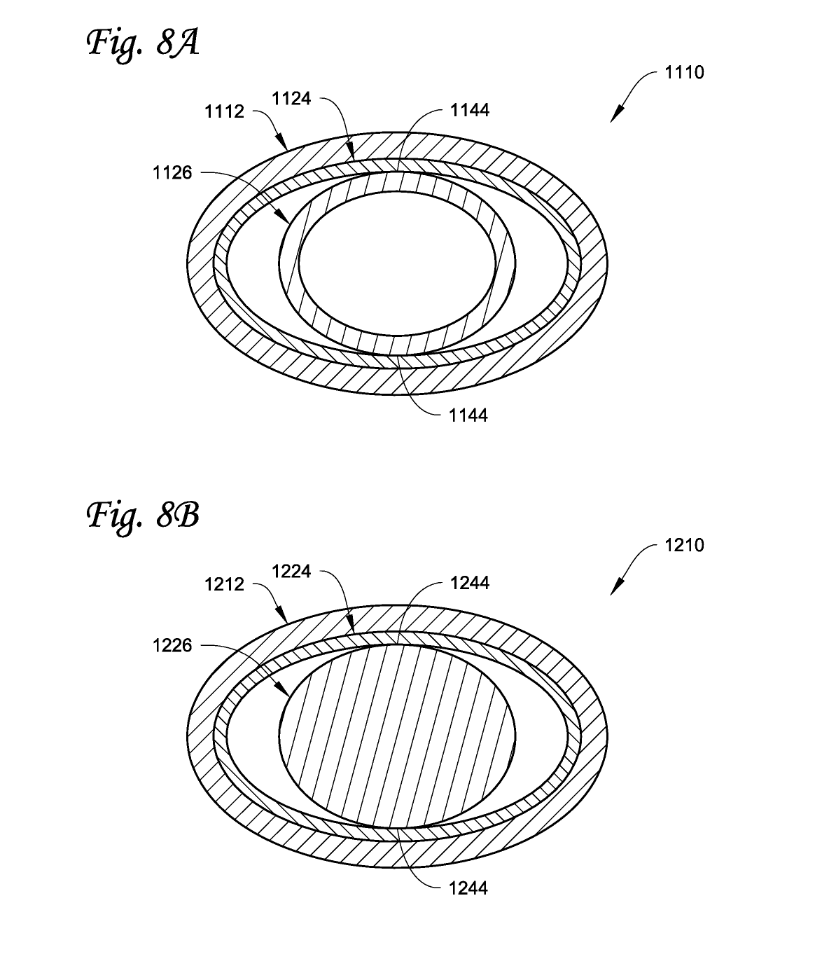

FIG. 8A is a cross-sectional view of a composite pole 1110. The composite pole 1110 comprises a large composite member 1112 including a first interior space and a medium composite member 1124 at least partially nested or disposed in the first interior space. As shown in FIG. 8A, the medium composite member 1124 has an outer circumference that is in close proximity with an inner circumference of the large composite member 1112. The medium composite member 1124 is sized to facilitate telescopical slidable movement of the medium composite member 1124 in relation to the large composite member 1112. The medium composite member 1124 can be retained to the large composite member 1112 by using auxiliary means such as adhesive or mechanical means, for example, screws or rivets. The adhesive can be, for example, a thermosetting adhesive, a chemical adhesive, a contact adhesive, a hot adhesive, or a pressure adhesive made of, for example, a polyester or epoxy resin. The medium composite member 1124 includes a second interior space in which a small composite member 1126 is at least partially nested or disposed. The small composite member 1126 has an outer circumference that is in close proximity with an inner circumference of the medium composite member 1124 at points 1144, where the small composite member 1126 can be retained in the medium composite member 1124 by methods similar to those discussed earlier in this paragraph. In the embodiment as shown in FIG. 8A, the small composite member 1126 is a hollow composite member.

FIG. 8B is a cross-sectional view of a composite pole 1210. The composite pole 1210 comprises a large composite member 1212 including a first interior space and a medium composite member 1224 at least partially nested or disposed in the first interior space. As shown in FIG. 8B, the medium composite member 1224 has an outer circumference that is in close proximity with an inner circumference of the large composite member 1212. The medium composite member 1224 is sized to facilitate telescopical slidable movement of the medium composite member 1224 in relation to the large composite member 1212. The medium composite member 1224 can be retained to the large composite member 1212 by methods similar to those discussed above regarding FIG. 8A. The medium composite member 1224 includes a second interior space in which a small composite member 1226 is at least partially nested or disposed the small composite member 1226 has an outer circumference that is in close proximity with an inner circumference of the medium composite member 1224 at points 1244, where the small composite member 1226 can be retained in the medium composite member 1224 by methods similar to those discussed regarding FIG. 8A. In the embodiment as shown in FIG. 8B, the small composite member 1226 is a solid composite member.

It is to be understood that the specific configurations of the composite members in FIGS. 8A-B can vary, for example, as discussed above regarding the composite member, e.g., as in FIGS. 2, 4 and 5A-B. It is also to be understood that the thickness of the composite members can take any form of thicker or thinner, constant or non-constant as design choice.

The embodiments disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A composite pole, comprising:
at least a first composite member including:
first and second ends;
an elongated body defined between the first and second ends;
a first interior space; and
a constant cross-section including:
an outer circumference having a first radius and a second radius;
an inner circumference; and
a wall thickness defined between the outer and inner circumferences,
wherein the first radius is not equal to the second radius.

2. The composite pole of claim 1, wherein the constant cross-section includes an elliptical outer circumference.

3. The composite pole of claim 1, wherein the constant cross-section further includes a constant wall thickness.

4. The composite pole of claim 1, wherein the outer circumference further includes an outer largest axis and an outer smallest axis, the inner circumference includes an inner largest axis and an inner smallest axis, a ratio between lengths of the largest and smallest axes of the outer circumference is greater than a ratio between lengths of the largest and smallest axes of the inner circumference.

5. The composite pole of claim 1, wherein the inner circumference has a third radius and a fourth radius, the third radius being not equal to the fourth radius.

6. The composite pole of claim 1, further comprising a second composite member at least partially disposed in the first interior space of the first composite member and including a second interior space and an outer circumference, at least a portion of the outer circumference of the second composite member is in close proximity with the inner circumference of the first composite member.

7. The composite pole of claim 6, further comprising a third composite member at least partially disposed in the second interior space of the second composite member and including an outer circumference, at least a portion of the outer circumference of the third composite member is in close proximity with an inner circumference of the second composite member.

8. The composite pole of claim 6, wherein the first composite member has a constant first thickness and the second composite member has a constant second thickness, the first thickness being greater than the second thickness.

9. A method for making a composite pole, comprising:
forming at least a first composite member including:
first and second ends;
an elongated body defined between the first and second ends;
a first interior space; and
a constant cross-section including:
an outer circumference having a first radius and a second radius;
an inner circumference; and
a thickness defined between the outer and inner circumferences,
wherein the first radius is not equal to the second radius.

10. The method for making a composite pole of claim 9, wherein forming at least a first composite member includes forming at least a first composite member including a constant cross-section having an elliptical outer circumference.

11. The method for making a composite pole of claim 9, wherein forming at least a first composite member includes forming includes forming a constant cross-section having a constant wall thickness.

12. The method for making a composite pole of claim 9, wherein forming at least a first composite member includes forming includes forming a constant cross-section having a ratio between lengths of largest and smallest axes of the outer circumference being greater than a ratio between lengths of largest and smallest axes of the inner circumference.

13. The method for making a composite pole of claim 9, wherein forming at least a first composite member includes forming an inner circumference that has a third radius and a fourth radius, the third radius being not equal to the fourth radius.

14. The method for making a composite pole of claim 9, further comprising disposing a second composite member at least partially in the first interior space of the first composite member,
where the second composite member includes a second interior space, and
where at least a portion of an outer circumference of the second composite member is in close proximity with the inner circumference of the first composite member.

15. The method for making a composite pole of claim 14, further comprising disposing a third composite member at least partially in the second interior space of the second composite member, where at least a portion of an outer circumference of the third composite member is in close proximity with an inner circumference of the second composite member.
